(19) United States
(12) Patent Application Publication
(10) Pub. No.: US 2020/0150673 A1
(43) Pub. Date: May 14, 2020

(54) TRACK GENERATING METHOD AND APPARATUS, AND UNMANNED GROUND VEHICLE

(71) Applicant: SZ DJI TECHNOLOGY CO., LTD., Shenzhen (CN)

(72) Inventors: Minjun QIU, Shenzhen (CN); Zhimeng SHANG, Shenzhen (CN); Jiahang YING, Shenzhen (CN); Jianyun MA, Shenzhen (CN)

(21) Appl. No.: 16/725,776

(22) Filed: Dec. 23, 2019

Related U.S. Application Data
(63) Continuation of application No. PCT/CN2017/113798, filed on Nov. 30, 2017.

(51) Int. Cl. G05D 1/02; G05D 1/00; G01C 21/36

(52) U.S. Cl. CPC G05D 1/0223; G01C 21/3614; G05D 1/0016; G05D 1/0268

(57) ABSTRACT

A method for generating a driving path includes obtaining driving parameters of each of multiple path points on an actual driving path inside a planned area, the driving parameters including at least one of a driving position, a velocity, an acceleration velocity, and a driving time, selecting N path points out of the multiple path points according to the driving parameters, N being an integer of greater than or equal to 2, and forming a planned driving path for an unmanned ground vehicle to move inside the planned area according to driving parameters of each of the N path points.

### CROSS-REFERENCE TO RELATED APPLICATION

This application is a continuation of International Application No. PCT/CN2017/113798, filed Nov. 30, 2017, the entire content of which is incorporated herein by reference.

### TECHNICAL FIELD

The present disclosure relates to unmanned vehicle technologies, and in particular to a method and an apparatus for generating a driving path, and unmanned ground vehicle incorporating the same.

### BACKGROUND

Unmanned tractors have entered the market, for use in field-ploughing, crop-harvesting, and pesticide-application. Such uses have been beneficial in agricultural areas by delivering time and labor efficiencies and extending farm equipment to its best capacities. The unmanned tractors are driverless and autonomous. With a driving path predetermined, the unmanned tractors may move along the predetermined driving path while carrying out tasks in ploughing land, harvesting crops, and applying pesticides. Certain existing technologies on setting a predetermined driving path require preparation of high-precision maps and then mapping high-precision driving paths via great deal of human labor, and further require high consistency between the high-precision maps and feedback from an actual operation. However, these efforts in generating high-precision maps and requiring high consistency between the maps and the real time operation feedback have been met with limited return-on-investment efficiencies.

### SUMMARY

In accordance with the disclosure, there is provided a path forming method including obtaining driving parameters of each of multiple path points on an actual driving path inside of a planned area, the driving parameters including at least one of a driving position, a velocity, an acceleration velocity, and a driving time, selecting N path points out of the multiple path points according to the driving parameters, N being an integer of greater than or equal to 2, and forming a planned driving path for an unmanned ground vehicle to move inside of the planned area according to driving parameters of each of the N path points.

Also in accordance with the disclosure, there is provided a path forming apparatus including a memory and processor coupled to the memory, the memory storing computer program instructions executable by the processor to perform obtaining driving parameters of each of multiple path points on an actual driving path inside of a planned area, the driving parameters including at least one of a driving position, a velocity, an acceleration velocity, and a driving time, selecting N path points out of the multiple path points according to the driving parameters, N being an integer of greater than or equal to 2, and forming a planned driving path for an unmanned ground vehicle to move inside of the planned area according to driving parameters of each of the N path points.

### BRIEF DESCRIPTION OF THE DRAWINGS

Objectives, features, and advantages of the embodiments are more readily understandable in reference to the accompanying drawings described below. In the accompanying drawings, the embodiments are described without limiting the scope of the present disclosure.

FIG. 1 is a schematic structural diagram of an unmanned driving system 100 according to one embodiment of the present disclosure.

FIG. 2 is a schematic diagram of a path forming method according to another embodiment of the present disclosure.

FIG. 3 is a schematic diagram of a generated driving path after user modification according to yet another embodiment of the present disclosure.

FIG. 4 is a schematic diagram of a path forming method according to yet another embodiment of the present disclosure.

FIG. 5 is a schematic diagram of a guiding path according to yet another embodiment of the present disclosure.

FIG. 6 is a schematic structural diagram of a path forming apparatus according to yet another embodiment of the present disclosure.

FIG. 7 is a schematic structural diagram of a path forming apparatus according to yet another embodiment of the present disclosure.

FIG. 8 is a schematic structural diagram of an unmanned ground vehicle according to yet another embodiment of the present disclosure.

FIG. 9 is a schematic structural diagram of an unmanned ground vehicle according to yet another embodiment of the present disclosure.

### DETAILED DESCRIPTION OF THE EMBODIMENTS

The present disclosure is described in view of the embodiments but the embodiments as described do not necessarily limit the scope of any of the claims. To those skilled in the technical art, many suitable changes and improvements may be made to the embodiments. Such suitable changes and improvements are understood to be included in the scope defined by the claims.

The present disclosure provides a path forming method and apparatus, and an unmanned ground vehicle incorporating the same. The unmanned ground vehicle may be, but are not limited to, an unmanned tractor or an unmanned robot.

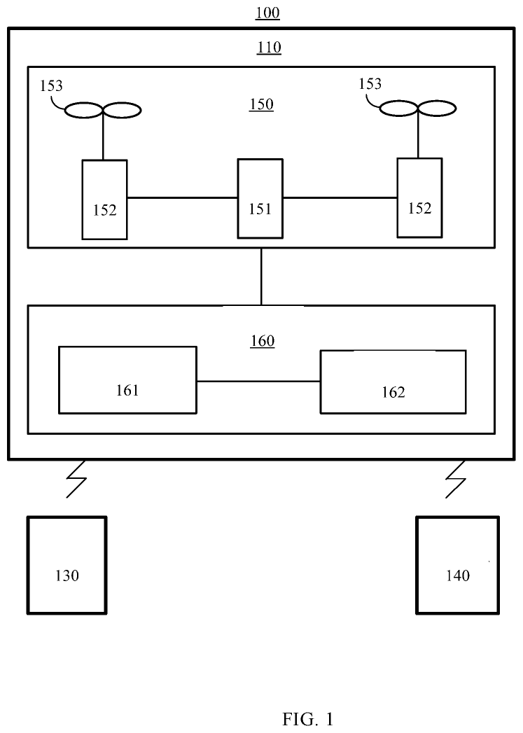

FIG. 1 is a schematic structural diagram of an unmanned driving system 100 according to one embodiment of the present disclosure and is described in view of an unmanned ground vehicle as an example.

The unmanned driving system 100 may include an unmanned ground vehicle 110, a display device 130, and a control equipment 140. The unmanned ground vehicle 110 may include a power system 150, a control system 160, and a vehicle frame. The unmanned ground vehicle 110 may be in wireless communication with the control equipment 140 and the display device 130.

The power system 150 may include one or more electric speed adjuster 151, one or more vehicle wheels 153, and one or more electric motors 152 corresponding to the one or more vehicle wheels 153. The electric motor 152 is connectively positioned between the electric speed adjuster 151 and the vehicle wheels 153. The electric motor 152 and the vehicle wheels 153 are positioned on the unmanned ground vehicle 110. The electric speed adjuster 151 is to receive drive signals from the control system 160, to provide drive electric flow to the electric motor 152 according to the drive signals, and to control the rotation speed of the electric motor 152. The electric motor 152 causes the vehicle wheels to rotate, to provide drive power to the unmanned ground vehicle 110, where the drive power causes the unmanned ground vehicle 110 to realize movement or driving with one or more degrees of freedom. The electric motor 152 may be a direct current (DC) electric motor or an alternating current (AC) electric motor. The electric motor 152 may be a brushless motor or a brushed motor.

The control system 160 includes a controller 161 and a sensor system 162. The sensor system 162 is to detect status information on the unmanned ground vehicle, particularly position and status information of the unmanned ground vehicle 110, in terms of position, angle, velocity, acceleration velocity, and angle velocity. The sensor system 162 may include at least one of a gyro, an ultrasonic sensor, an electronic compass, an inertial measurement unit (IMU), a visual sensor, a global position system, a global navigation satellite system, and a barometer. For example, the global navigation satellite system may be a global positioning system (GPS). The controller 161 controls the movement or driving of the unmanned ground vehicle 110. For example, the movement or driving of the unmanned ground vehicle 110 may be controlled according to the status information obtained through the sensor system 162. The controller 161 may exert control on the unmanned ground vehicle 110 via preset instructions, or via responding to one or more control instructions from the control equipment 140.

The display device 130 may be in wireless communication with the unmanned ground vehicle 110 and may be used to show status information of the unmanned ground vehicle. The display device 130 may show thereupon images captured by an imaging device disposed on the unmanned ground vehicle 110. The display device 130 may be an independent device or may be integrated into the control equipment 140.

The control equipment 140 may be in wireless communication with the unmanned ground vehicle 110 to exert control on the unmanned ground vehicle 110.

Above-identified naming of various components of the unmanned driving system is for illustration purpose only and does not necessarily place any particular limit on the embodiment(s) of the present disclosure.

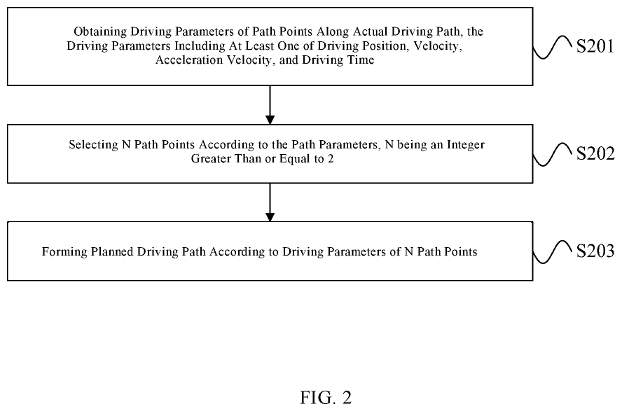

FIG. 2 is a schematic diagram of a path forming method. As illustratively depicted in FIG. 2, the embodiment may include the following step(s).

At step S201, driving parameters of each of multiple path points of an actual driving path inside of a planned area are obtained, where the driving parameters include at least one of a driving position, a velocity, an acceleration velocity, and a driving time.

A user may manually control the movement of the unmanned ground vehicle inside of the planned area; or the user may operate an agricultural farm tractor inside of the planned area. In the example of an agricultural farm tractor, an inertial measurement system (IMS) and a real time kinematic (RTK) detection and control system are started at a starting point. The user leads the farm tractor to move along a path, during which driving parameters are obtained via the inertial measurement system and the real time kinematic system. The driving parameters include at least one of a driving position, a velocity, an acceleration velocity, and a driving time. The velocity and the acceleration velocity may be determined by the inertial measurement system. The driving position and the driving time may be determined by the RTK system. The driving path is formed of multiple path points, and the driving parameters may be obtained in real time, and driving parameters may then be obtained for each of the multiple path points.

At step S202, N path points are obtained from the actual driving path according to the driving parameters, where N is an integer of greater than or equal to 2.

At step S203, a planned driving path is formed according to the driving parameters for each of the N path points, for the unmanned ground vehicle to move long inside of the planned area.

According to the driving parameters of each of the multiple path points of the actual driving path, the N path points are selected from the actual driving path, and the N path points are employed to form a generated driving path. At least two path points are needed to form a path, N there is an integer greater than or equal to 2. The planned driving path is formed according to the driving parameters of each of the N path points. The unmanned ground vehicle may then follow the planned driving path while moving inside of the planned area, such that the driving path taken by the unmanned ground vehicle is a close approximate to the actual driving path as mentioned in step S201.

The N path points are obtained from the actual driving path according to the driving parameters of each of the multiple path points along the actual driving path inside of the planned area. A planned driving path to be used inside of the planned area for the unmanned ground vehicle may be generated according to the driving parameters of each of the N path points. The planned driving path is formed based on the driving parameters of each of the N path points, where the N path points are each from the actual driving path, and where the driving parameters of the N path points are therefrom the actual driving path, and accordingly, the generated driving path is very close to the actual driving path. A user may only need to conduct a one-time drive along the actual driving path to obtain driving parameters; and there is no necessary need to compose high accuracy maps or conduct path planning. Accordingly, the path forming method according to embodiment(s) of the present disclosure is provided with relatively greater accuracy and higher efficiencies.

In some embodiments, step S202 may include steps S2021 and S2022.

At step S2021, a path curvature of each of the multiple path points along the actual driving path is obtained according to the driving parameters as captured.

The path curvature of each of the path points is obtained according to the driving parameters of each of the path points along the actual driving path.

In some embodiments, and at step S2021, path points with abnormal path curvatures may be deleted and excluded from further consideration. Path curvature change rate of each of the path points may be obtained according to the path curvature of each of the path points after deletion of path points with abnormal path curvatures. Accordingly, outliers due to noises may be eliminated in the process of detecting driving parameters, such that forming planned driving path via the N path points may be conducted with greater accuracy. Low-pass filtering may be used to eliminate path points with abnormal path curvatures. In general, path points with abnormal path curvatures are signals with relatively high frequency.

Step S2021 may include steps S20211 and S20212.

At step S20211, path curvature radius of each of the path points is obtained according to the driving parameters of the path points, and according to a correlation between the driving parameters and the path curvature radius.

The path curvature radius is related to the driving parameters with a certain correlation. Accordingly, the path curvature radius of each of the path points may be obtained according to the driving parameters of the path points, and according to a correlation between the driving parameters and the path curvature radius

The path curvature radius may be obtained via equation (1).

R=|x(t)″−x(t)″y(t)′|/((x(t)′)̂2+(y(t)′)̂2)̂(3/2) (1)

Relevant to equation (1), x(t) and y(t) each represent a driving position, R represents a path curvature radius, x(t) represents a distance of a path point relative to a preset base point facing the direction north at time t, y(t) represents a distance of the path point relative to the preset base point facing the direction east at time t. Parameter x(t)′ represents a first derivative of x(t), for example, a velocity in the direction of south north. Parameter x(t)″ represents a second derivative of x(t), for example, an acceleration velocity in the direction of south north. Parameter y(t)′ represents a first derivative of y(t), for example, a velocity in the direction of east west. Parameter y(t)″ represents a second derivative of y(t), for example, an acceleration velocity in the direction of east west.

At step S20212, the path curvature of each of the path points is obtained according to the path curvature radius of each of the path points.

The path curvature radius is of a certain correlation to the path curvature. The path curvature of each of the path points may accordingly be obtained according to the path curvature radius of each of the path points.

The path curvature of each of the path points may be obtained according to equation (2) k=1/R, where k is the path curvature and R is the path curvature radius.

At step S2022, the N path points may be obtained from the multiple path points according to the path curvature of each of the path points.

The N path points may be obtained from the actual driving path according to the path curvature of each of the path points.

In some embodiments, and at steps S2021 and S2022, the multiple path points are path points exclusive of path points with abnormal path curvatures.

Step S2022 may include steps S20221 and S20222.

At step S20221, path curvature change rate of each of the path points may be obtained according to the path curvature of each of the path points.

The path curvature is related to path curvature change rate with a certain correlation therebetween. The path curvature change rate of each of the path points may be obtained after the path curvature is obtained. The path curvature change rate is obtained according to a first derivative of the path curvature radius of each of the path points.

According to equation (3) α=k′, the path curvature change rate of each of the path points is obtained, where k represents the path curvature, a represents path curvature change rate, and k′ is a first derivative of k.

At step S20222, the N path points are obtained from the multiple path points according to the path curvature change rate of each of the path points.

The N path points are obtained from the multiple path points along the actual driving path, according to the path curvature change rate of each of the path points.

The path curvature change rate of each of the path points is compared to a path curvature change rate threshold. When the path curvature change rate of a path point is greater than the path curvature change rate threshold, the path point is included as one of the N path points. When the path curvature change rate of a path point is smaller than or equal to the path curvature change rate threshold, the path point is excluded from the N path points. Accordingly, path points along the actual driving path whose path curvature change rate is greater than the path curvature change rate threshold are included in the N path points.

Step S203 may include steps S2031 and S2032.

At step S2031, a generated driving path is formed according to the driving parameters of each of the N path points and according to the preset path forming rule.

In this embodiment, and after the driving parameters of each of the N path points are obtained, the generated driving path is formed according to the driving parameters of each of the N path points and according to the preset path forming rule.

The preset path forming rule includes a fifth-order polynomial among a driving position, a velocity, an acceleration velocity, and a driving time of each of the path points.

The generated driving path connects at least two adjacent path points, according to driving parameters of the two adjacent path points of the N path points, and according to the preset path forming rule.

There are, for example, two adjacent path points, namely path point 1 and path point 2. The path point 1 is of a driving position (x1, y1), a velocity (vx1, vy1), an acceleration velocity (ax1, ay1), and a driving time t1. The path point 2 is of a driving position (x2, y2), a velocity (vx2, vy2), an acceleration velocity (ax2, ay2), and a driving time t2.

The fifth-order polynomial is f(t)=at⁵+bt⁴+ct³+dt²+et+f. The equation (4) shown below is established along direction x, where the direction x may be the direction of north.

$$[ \begin{matrix}0 & 0 & 0 & 0 & 0 & 1 \\ 0 & 0 & 0 & 0 & 1 & 0 \\ 0 & 0 & 0 & 2 & 0 & 0 \\ {t}^{5} & {t}^{4} & {t}^{3} & {t}^{2} & t & 1 \\ 5 {t}^{4} & 4 {t}^{3} & 3 {t}^{2} & 2 t & 1 & 0 \\ 20 {t}^{3} & 12 {t}^{2} & 6 {t}^{1} & 2 & 0 & 0\end{matrix} ] [ \begin{matrix}a \\ b \\ c \\ d \\ e \\ f\end{matrix} ] = [ \begin{matrix}{x}_{1} \\ {vx}_{1} \\ {ax}_{1} \\ {x}_{2} \\ {vx}_{2} \\ {ax}_{2}\end{matrix} ]$$

Parameters a, b, c, d, e, and f are determined by solving the equation (4).

Regarding the fifth-order polynomial, a first derivative is a velocity, and a second derivative is an acceleration velocity. During autonomous movement or driving, parameters including the driving position, the velocity, and the acceleration velocity of each of the path points may be determined at time t by inputting time t into equation (4).

Parameters along direction y, such as a direction of the east, may be similarly obtained.

At step S2032, the planned driving path is formed according to the generated driving path for the unmanned ground vehicle to move along inside the planned area.

In this embodiment, and after the generated driving path is obtained, the planned driving path is formed according to the generated driving path for the unmanned ground vehicle to move along inside the planned area.

Step S2032 may include steps S20321 and S20323.

At step S20321, M sampled path points are selected from the generated driving path, where M is an integer greater than or equal to 1.

In this embodiment, after the generated driving path is obtained, the M sampled path points are selected from the generated driving path, where M is an integer greater than or equal to 1, and M is smaller than or equal to N. The M sampled path points may be of equal spacing between any two adjacent points along the generated driving path, or may be from the N path points of equal spacing between any two adjacent points.

At steps S20322, a difference between the generated driving path and the actual driving path is determined according to the M sampled path points.

In this embodiment, after the M sampled path points are obtained, the difference between the generated driving path and the actual driving path is determined according to the M sampled path points.

At step S20322, the shortest distance between each of the M path points relative to the actual driving path is determined. The difference between the generated driving path and the actual driving path is determined according to the shortest distance of each of the M path points relative to the actual driving path. An average of shortest distances of each of the M path points relative to the actual driving path, such as (d1+d2+ . . . +dM)/M, may be set as the difference between the generated driving path and the actual driving path. In other embodiments, value other than the average may be set as the difference, for example, a weight average, the smallest of the sampled values, or the biggest of the sampled values.

At step S20323, when the difference is smaller than or equal to the difference threshold, the planned driving path is obtained according to the generated driving path.

In this embodiment, the difference between the generated driving path and the actual driving path is compared to the difference threshold. When the difference is smaller than or equal to the difference threshold, the planned driving path is formed according to the generated driving path. Accordingly, the difference between the planned driving path and the actual driving path is small enough to ensure that the planned driving path is obtained with certain accuracy.

When the difference is greater than the difference threshold, the path curvature change rate is adjusted to be smaller or is decreased. Each adjustment may be of same increment. After the path curvature change rate threshold has been adjusted to a smaller value, path points whose path curvature change rate is greater than the renewed or decreased path curvature change rate are included in the N path points. Expectedly, there may be more path points qualified for inclusion into the N path points. Thereafter, the planned driving path may then be obtained according to the N path points after the adjustment on the path curvature change rate threshold.

In some embodiments, the generated driving path and the actual driving path are displayed on a display interface, such that the difference between the generated driving path and the actual driving path may be more readily presented to a user, where the user may choose to adjust the generated driving path as the user sees fit.

When the user chooses not to make any adjustments to the generated driving path, the user inputs a confirmation such that the generated driving path is confirmed without any adjustment. The planned driving path is determined according to the generated driving path for the unmanned ground vehicle to move along inside the planned area. The generated driving path is thus set as the planned driving path.

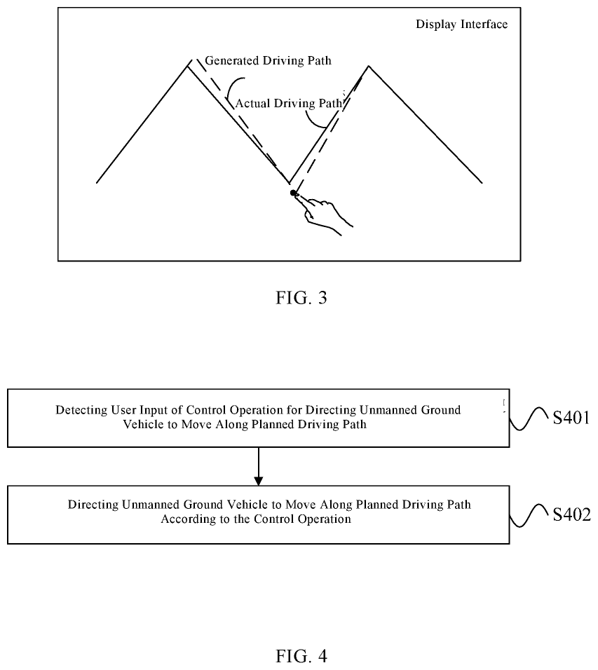

The user may modify or render adjustment on the generated driving path via an adjustment operation, which includes at least one of deleting a path point, adding a path point, or changing a path point. The generated driving path is then updated in view of the adjustment operation. The generated driving path as updated may be displayed on a display interface to provide a user a readily and visual access to the generated driving path as update and for the user to render additional adjustment as the user sees desirable. Additional adjustment implemented as needed. When no further adjustment is needed, the user may input via the display interface a confirmation on the generated driving path. The planned driving path along with the unmanned ground vehicle may move inside the planned area may be determined according to the confirmation from the user and according to the generated driving path as modified and confirmed by the user. As illustratively depicted in FIG. 3, the user may render adjustment or modification to the position of the path point such as deleting the path point, to form a generated driving path which is at least partially in alignment with the actual driving path.

FIG. 4 is a schematic flow chart diagram of a path forming method. As illustratively depicted in FIG. 4, and further in view of FIG. 2, the method further includes, after the step S203:

At step S401, the user inputs a control instruction, the control instruction being to direct the unmanned ground vehicle to move along the planned driving path.

At step S402, and according to the control instruction, the unmanned ground vehicle moves along the planned driving path inside the planned area.

When the user desires to exert control on the movement or driving of the unmanned ground vehicle along the planned driving path, the user inputs a control instruction, which directs to the unmanned ground vehicle to move along the planned driving path. In this embodiment, and after the user inputs the control instruction, the control instruction directs the unmanned ground vehicle to move along the planned driving path.

The apparatus to execute the method illustratively depicted in FIG. 4 may be the same as the apparatus to execute the method illustratively depicted in FIG. 2. After the planned driving path is formed, the steps S401 and S402 are executed. Alternatively, the apparatus to execute the method illustratively depicted in FIG. 4 may be different than the apparatus to execute the method illustratively depicted in FIG. 2. After the planned driving path is formed, the steps S401 and S402 are executed.

In this embodiment, via a control on the movement or driving of the unmanned ground vehicle along the planned driving path inside the planned area, the actual driving path of the unmanned ground vehicle is made very close to the driving path that the user desires, and accordingly user satisfaction is improved.

In some embodiments, the starting path point of the planned driving path and the starting direction angle at the starting path point are obtained, for example, via the RTK detection system which may be used to detect direction angles. The starting path point may be the starting position of the actual driving path, and the starting direction angle may be the direction angle of the actual driving path at the starting position. The direction angle may be defined as an angle of the vehicle body relative to the direction north.

When the current position of the unmanned ground vehicle is not the starting path point of the planned driving path, and/or when the current direction angle is not the starting direction angle at the starting path point, the current position of the unmanned ground vehicle is to be adjusted to the starting path point and the current direction angle of the unmanned ground vehicle is to be adjusted to the starting direction angle, to ensure that the unmanned ground vehicle stay on track of the planned driving path. A guiding path is formed according to the current position of the unmanned ground vehicle, the current direction angle of the unmanned ground vehicle, the starting path point, and the starting direction angle. The current position of the unmanned ground vehicle is set as a starting position of the guiding path, the starting path point is set as an end position of the guiding path, the current direction angle of the unmanned ground vehicle is set as a starting direction angle of the guiding path, and the starting direction angle is set as an end direction angle of the guiding path. The unmanned ground vehicle is then directed to move along the guiding path, and to eventually arrive at the starting path point and be with the starting direction angle.

In some embodiments, the guiding path may include a curved portion to facilitate adjustment on the position and/or direction angle of the unmanned ground vehicle.

In some embodiments, the guiding path may also include a relatively straighter portion, a portion less curvy than the curved portion. For example, the guiding path may include first and second end portion and a middle portion positioned between the first and second end portions, where the middle portion is curvier than at least one of the first and second end portions. In some embodiments, the first end portion is design for acceleration and the second end portion is designed for deacceleration.

In some embodiments, the current position of the unmanned ground vehicle is not precisely the starting path point. The guiding path helps guiding the unmanned ground vehicle (such as an agricultural tractor) to move from its current position to the starting path point.

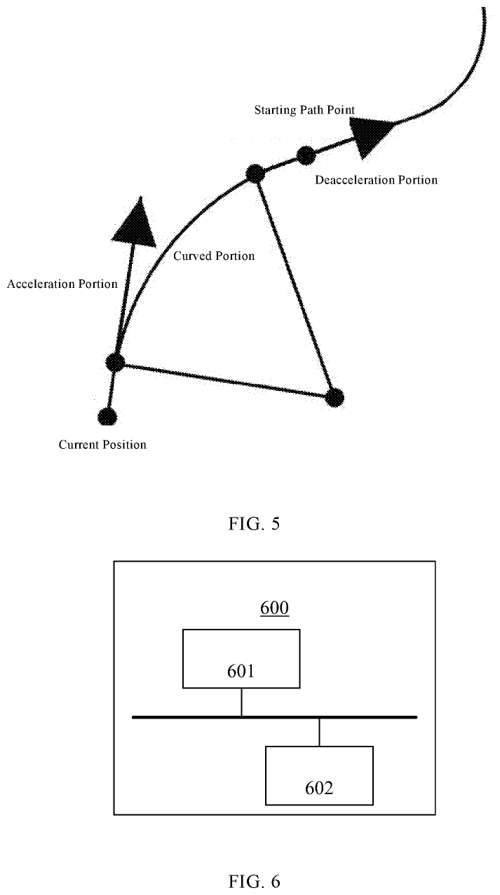

According to actual capacity of the unmanned ground vehicle in both acceleration and deacceleration, the unmanned ground vehicle is directed to move along the first end portion of the guiding path to accelerate and along the second end portion of the guiding path to deaccelerate. The first and second end portions of the guiding path may be connected therebetween with the middle portion which is relatively curvier to help the unmanned ground vehicle to engage in a smooth position transition. FIG. 5 is a schematic diagram of a guiding path.

Regarding the guiding path, its starting position is (x_{A}, y_{A}), its velocity is (vx_{A}, vy_{A}), its ending position is (x_{B}, y_{B}), and its velocity is (vx_{B}, vy_{B}). The velocity at the staring position may be the same to the velocity at the ending position. The angle directions at both the starting and end positions may be different from each other. Equation (5) is shown below.

$$x = - \frac{{vy}_{A}}{{vx}_{A}} ( y - {y}_{A} ) + {x}_{A}$$

$$x = - \frac{{vy}_{B}}{{vx}_{B}} ( y - {y}_{B} ) + {x}_{B}$$

According to equation (5) shown above, center coordinates (x, y) may be obtained, and radius r=\sqrt{(x²−x_{A}²)+(y²−y_{A}²)} may also be obtained.

Parameter x may then be obtained via equation x=r cosθ, y=r sinθ, where θ is a direction angle of the unmanned ground vehicle relative to the circle center.

The guiding path may thus be obtained.

The present disclosure further provides a computer storage medium storing computer program instructions executable by a processor to perform a path forming method illustratively depicted in FIG. 2 and FIG. 4.

FIG. 6 is a schematic structural diagram of a path forming apparatus. As illustratively depicted in FIG. 6, the path forming apparatus 600 includes a memory 601 and a processor 602. The processor 602 may be a central processing unit (CPU), or any other suitable processors, such as digital signal processor (DSP), application specific integrated circuit (ASIC), field-programmable gate array (FPGA), or any other programmable logic devices, discrete gate or transistor logic devices, or discrete hardware components. The processor may be a microprocessor or any suitable processor.

The memory 601 is employed to store computer program instructions.

The processor 602 is employed to execute the computer program instructions as stored in the memory 601 to perform the following step(s).

Driving parameters of each of multiple path points on an actual driving path inside a planned area are obtained, the driving parameters including at least one of a driving position, a velocity, an acceleration velocity, and a driving time.

N path points are selected out of the multiple path points according to the driving parameters, N being an integer of greater than or equal to 2. A planned driving path is formed for an unmanned ground vehicle to move inside the planned area according to the driving parameters of each of the N path points.

In some embodiment, the processor is further configured to perform: obtaining a path curvature of each of the multiple path points of the actual driving path according to the driving parameters of each of the multiple path points; and selecting the N path points out of the multiple path points according to the path curvature of each of the multiple path points.

In some embodiments, the processor is further configured to perform: obtaining a path curvature change rate of each of the multiple path points according to the curvature of each of the multiple path points; and selecting the N path points out of the multiple path points according to the path curvature change rate of each of the multiple path points.

In some embodiments, the processor is further configured to perform, when a path curvature change rate is greater than a path curvature change rate threshold, selecting the path point corresponding to the path curvature change rate as one of the N path points.

In some embodiments, the processor is further configured to perform deleting from the multiple path points a path point with abnormal curvature to obtain updated multiple path points; and obtaining the path curvature change rate of each of the updated multiple path points according to the curvature of each of the updated multiple path points.

In some embodiments, the processor 602 is further configured to perform obtaining a path curvature radius of each of the multiple path points according to the driving parameters and according to a correlation between the driving parameters and the path curvature radius, and obtaining the path curvature according to the path curvature radius.

In some embodiments, the processor 602 is further configured to perform obtaining the path curvature change rate according to a first derivative of a path curvature radius of each of the multiple path points.

In some embodiments, the processor 602 is further configured to perform forming a generated driving path according to driving parameters of the N path points and according to a preset path forming rule, where the preset path forming rule includes a fifth-order polynomial representing a relationship among the driving position, the velocity, the acceleration velocity, and the driving time of each of the multiple path points.

In some embodiments, the processor 602 is further configured to perform sampling M path points from the generated driving path, M being an integer of greater than or equal to 1, determining a difference between the generated driving path and the actual driving path according to the M path points, and when the difference is smaller than or equal to a difference threshold, forming the planned driving path according to the generated driving path.

In some embodiments, the processor 602 is further configured to perform determining a shortest distance of each of the M path points relative to the actual driving path, and determining the difference between the generated driving path and the actual driving path according to the M path points according to the shortest distance of each of the M path points relative to the actual driving path.

In some embodiments, the processor 602 is further configured to perform obtaining an average of the shortest distance of each of the M path points relative to the actual driving path, and setting the average as the difference between the generated driving path and the actual driving path.

In some embodiments, the processor 602 is further configured to perform, when the difference is greater than the difference threshold, decreasing the path curvature threshold.

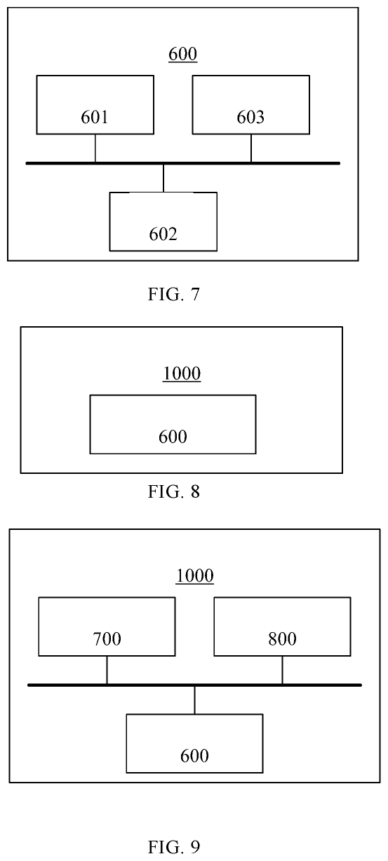

FIG. 7 is a schematic structural diagram of a path forming apparatus. As illustratively depicted in FIG. 7, and further in view of FIG. 6, the path forming apparatus 600 further includes a display interface 603.

In some embodiments, the display interface 603 is employed to display the generated driving path and the actual driving path, prior to formation of planned driving path for the unmanned ground vehicle to move along inside the planned area.

The processor 602 is further configured to detect a confirmation operation inputted by the user via the display interface 603, and to direct the unmanned ground vehicle to move along the planned driving path inside the planned area according to the confirmation operation and the generated driving path formed in response to the confirmation operation.

In some embodiments, the processor 602 is further configured to detect a modification operation inputted by the user via the display interface, to exert modification or adjustment on the generated driving path according to the modification operation, where the modification operation includes at least one of deleting a path point, adding a path point, or change position of a path point.

The display interface 603 may further be used to display the driving path after the adjustment.

The processor 602 determines the planned driving path according to the confirmation inputted by the user and also according to the generated driving path. In particular, the planned driving path is determined according to the generated driving path as modified or adjusted and confirmed by the user.

In some embodiments, the processor 602 is further configured to direct the unmanned ground vehicle to move along the planned driving path, upon detecting via the display interface 603 the control instruction inputted by the user, after the planned driving path is formed in accordance with the driving parameters of each of the N path points. The processor 602 is further configured to direct the unmanned ground vehicle to move along the planned driving path inside the planned area according to the control instruction.

In some embodiments, the processor 602 is further configured to obtaining a starting path point of the planned driving path and a starting direction angle of the starting path point, when a current position of the unmanned ground vehicle is different than the starting path point, and/or when a current direction angle of the unmanned ground vehicle is different than the starting direction angle, forming a guiding path according to the current position, the starting path point, the current direction angle, and the starting direction angle, and directing the unmanned ground vehicle to move along the guiding path, wherein an initial point of the guiding path is the current position of the unmanned ground vehicle, an end point of the guiding path is the starting path point, an initial direction angle of the unmanned ground vehicle at the initial point is the current direction angle of the unmanned ground vehicle, and an end direction angle of the unmanned ground vehicle is the starting direction angle, and wherein all angles are each an angle of a vehicle body of the unmanned ground vehicle relative to direction of the north.

In some embodiments, the guiding path includes first and second end portions and a middle portion positioned between the first and second end portions, the middle portion being curvier than at least one of the first and second end portions.

FIG. 8 is a schematic structural diagram of an unmanned ground vehicle. As illustratively depicted in FIG. 8, the unmanned ground vehicle 1000 includes a path forming apparatus 600. The path forming apparatus 600 may adopt the structure as illustratively depicted in FIG. 6 or FIG. 7. The path forming apparatus 600 may be executed to perform the path forming method described herein elsewhere.

FIG. 9 is a schematic structural diagram of an unmanned ground vehicle. As illustratively depicted in FIG. 9, and further in view of FIG. 8, the unmanned ground vehicle 1000 further includes an inertial measurement system 700 and an RTK detection system 800, where the path forming apparatus 600 is in communication with the inertial measurement system 700 and the RTK detection system 800.

The inertial measurement system 700 may be used to collect the velocity and the acceleration velocity of the driving parameters.

The RTK detection system 800 is employed to collect the driving position, the driving time, and the direction angle of the driving parameters.

The path forming apparatus 600 is further employed to collect via the inertial measurement system 700 at least one of the velocity, the acceleration velocity, and/or to collect via the RTK detection system at least one of the driving position, the driving time, and the direction angle.

In some embodiments, the unmanned ground vehicle 1000 may be an unmanned tractor.

Devices, systems, programs, and methods in actions, orders, steps, and periods, as referenced to in the present disclosure, the claims, and the drawings, may be in any suitable order. In particular, terms such as “first” and “next” may be used to simplify the task of description, but not to imply that such order is necessary.

Several functional units of the embodiments of the present disclosure may be integrated into a processing unit, or may each exist as an independent entity. Each of such units may be presented as a hardware unit or a combination or integration of a hardware and a software.

The software function units may be stored in a computer readable storage medium. The storage medium includes instructions when executed cause to the processor to perform one or more of the steps described herein. Such storage medium may include a U-disk, a mobile hard disk, a read-only memory (ROM), a random-access memory (RAM), and any other suitable storage disks and discs.

The present disclosure is described in view of the embodiments but the embodiments as described do not necessarily limit the scope of any of the claims. Certain embodiments or features of the embodiments described herein may be combined; however, not all such combinations are necessarily required for the solutions to the disclosure. To those skilled in the technical art, many suitable changes and improvements may be made to the embodiments. Such suitable changes and improvements are understood to be included in the scope defined by the claims.

What is claimed is:

1. A method of generating a driving path, comprising:
obtaining driving parameters of each of multiple path points on an actual driving path inside a planned area, the driving parameters including at least one of a driving position, a velocity, an acceleration velocity, and a driving time;
selecting N path points out of the multiple path points according to the driving parameters, N being an integer of greater than or equal to 2; and
forming a planned driving path for an unmanned ground vehicle to move inside the planned area according to driving parameters of each of the N path points.

2. The method of claim 1, wherein selecting the N path points out of the multiple path points according to the driving parameters includes:
obtaining a path curvature of each of the multiple path points of the actual driving path according to the driving parameters of each of the multiple path points; and
selecting the N path points out of the multiple path points according to the path curvature of each of the multiple path points.

3. The method of claim 2, wherein selecting the N path points out of the multiple path points according to the path curvature of each of the multiple path points includes:
obtaining a path curvature change rate of each of the multiple path points according to the path curvature of each of the multiple path points; and
selecting the N path points out of the multiple path points according to the path curvature change rate of each of the multiple path points.

4. The method of claim 3, wherein selecting the N path points out of the multiple path points according to the path curvature change rate of each of the multiple path points includes:
when the path curvature change rate is greater than a path curvature change rate threshold, selecting a path point corresponding to the path curvature change rate as one of the N path points.

5. The method of claim 3, wherein obtaining the path curvature change rate of each of the multiple path points according to the path curvature of each of the multiple path points includes:
deleting from the multiple path points a path point with abnormal path curvature to obtain updated multiple path points; and
obtaining the path curvature change rate of each of the updated multiple path points according to the path curvature of each of the updated multiple path points.

6. The method of claim 2, wherein obtaining the path curvature of each of the multiple path points of the actual driving path according to the driving parameters of each of the multiple path points includes:
obtaining a path curvature radius of each of the multiple path points according to the driving parameters and according to a correlation between the driving parameters and the path curvature radius; and
obtaining the path curvature according to the path curvature radius.

7. The method of claim 3, wherein obtaining the path curvature change rate of each of the multiple path points according to the path curvature of each of the multiple path points includes:
obtaining the path curvature change rate according to a first derivative of a path curvature radius of each of the multiple path points.

8. The method of claim 1, wherein forming the planned driving path for the unmanned ground vehicle to move inside the planned area according to the driving parameters of each of the N path points includes:
forming a generated driving path according to the driving parameters and a preset path forming rule; and
forming the planned driving path according to the generated driving path.

9. The method of claim 8, wherein the preset path forming rule includes a fifth-order polynomial representing a relationship among the driving position, the velocity, the acceleration velocity, and the driving time of each of the multiple path points.

10. The method of claim 8, wherein forming the planned driving path according to the generated driving path includes:
sampling M path points from the generated driving path, M being an integer of greater than or equal to 1;
determining a difference between the generated driving path and the actual driving path according to the M path points; and
when the difference is smaller than or equal to a difference threshold, forming the planned driving path according to the generated driving path.

11. The method of claim 10, wherein determining the difference between the generated driving path and the actual driving path according to the M path points includes:
determining a shortest distance of each of the M path points relative to the actual driving path; and
determining the difference between the generated driving path and the actual driving path according to the M path points according to the shortest distance of each of the M path points relative to the actual driving path.

12. The method of claim 11, wherein determining the difference between the generated driving path and the actual driving path according to the M path points according to the shortest distance of each of the M path points relative to the actual driving path includes:
obtaining an average of shortest distances of the M path points relative to the actual driving path; and
setting the average as the difference between the generated driving path and the actual driving path.

13. The method of claim 10, further comprising:
when the difference is greater than the difference threshold, decreasing the path curvature threshold.

14. The method of claim 8, wherein forming the planned driving path according to the generated driving path includes:
displaying, on a display interface, the generated driving path and the actual driving path;
receiving a user input via the display interface, the user input being to confirm the generated driving path; and
forming the planned driving path according to the generated driving path as confirmed.

15. The method of claim 14, further comprising:
receiving a second user input via the display interface;
modifying the generated driving path according to the second user input, wherein modifying the generated driving path includes at least one of deleting a path point from the generated driving path, adding a path point into the generated driving path, and change position of a path point of the generated driving path;
displaying, in the display interface, the generated driving path as modified; and
forming the planned driving path according to the generated driving path as modified.

16. The method of claim 1, wherein forming the planned driving path for the unmanned ground vehicle to move inside the planned area according to the driving parameters of each of the N path points includes:
receiving a control instruction from a user; and
directing the unmanned ground vehicle to move inside the planned area according to the planned driving path according to the control instruction.

17. The method of claim 16, further comprising:
obtaining a starting path point of the planned driving path and a starting direction angle of the starting path point;
when a current position of the unmanned ground vehicle is different than the starting path point, and/or when a current direction angle of the unmanned ground vehicle is different than the starting direction angle, forming a guiding path according to the current position, the starting path point, the current direction angle, and the starting direction angle; and
directing the unmanned ground vehicle to move along the guiding path, wherein an initial point of the guiding path is the current position of the unmanned ground vehicle, an end point of the guiding path is the starting path point, an initial direction angle of the unmanned ground vehicle at the initial point is the current direction angle of the unmanned ground vehicle, and an end direction angle of the unmanned ground vehicle is the starting direction angle, and wherein all angles are each an angle of a vehicle body of the unmanned ground vehicle relative to a direction of north.

18. The method of claim 17, wherein the guiding path includes first and second end portions and a middle portion positioned between the first and second end portions, the middle portion being curvier than at least one of the first and second end portions.

19. An apparatus for generating a driving path, the apparatus comprising a memory and processor coupled to the memory, the memory storing computer program instructions executable by the processor to perform:
obtaining driving parameters of each of multiple path points on an actual driving path inside a planned area, the driving parameters including at least one of a driving position, a velocity, an acceleration velocity, and a driving time;
selecting N path points out of the multiple path points according to the driving parameters, N being an integer of greater than or equal to 2; and
forming a planned driving path for an unmanned ground vehicle to move inside the planned area according to the driving parameters of each of the N path points.
